(19) United States
(12) Patent Application Publication
(10) Pub. No.: US 2016/0262372 A1
(43) Pub. Date: Sep. 15, 2016

(54) Extermination Treatment Appliance And Method

(71) Applicants: Cornell Kunz, Milwaukee, WI (US); Steven Yahr, Colgate, WI (US)

(72) Inventors: Cornell Kunz, Milwaukee, WI (US); Steven Yahr, Colgate, WI (US)

(21) Appl. No.: 14/657,748

(22) Filed: Mar. 13, 2015

(51) Int. Cl. A01M 9/00; E04B 1/72; A01M 1/24; A01M 13/00; B05B 1/00

(52) U.S. Cl. CPC A01M 9/00; A01M 13/00; A01M 9/0007; A01M 9/0038; B05B 1/00; A01M 1/24; E04B 1/72

(57) ABSTRACT

A system and method for applying extermination materials that includes a chamber for containing a volume of an extermination material, a gas source, and an applicator that are fluidly connected to one another. The chamber houses a dry exterminating treatment material that is communicated to the applicator by a flow originating from the gas source. The extermination treatment material is atomized and expelled from an injector supported by the applicator. The injector is constructed to pass through a wall covering and discharge the atomized treatment material into a wall cavity.

### FIELD OF THE INVENTION

The present invention relates generally to a device or an appliance and method associated with the extermination of pests and, more particularly, to an appliance that is constructed to deliver an exterminating treatment material through wall coverings and into wall cavities with only a reduced blemish to the wall covering material.

### BACKGROUND OF THE INVENTION

Various chemicals, pesticides, and other extermination materials are routinely applied to areas where pest infestations occur. For instance, these materials are oftentimes applied by a wand or other handheld device that allows the material to be spread or sprayed around the infestation area.

Although outside applications can be provided in dry or spray form with liberal application of the pest treatment materials, such processes are commonly ill-suited to indoor pest abatement processes. When the infestation occurs indoors, the extermination material is oftentimes applied along a base board of infested and commonly structurally adjoining areas such as adjacent rooms. A common problem with this approach is that the extermination material must be sparingly applied to create an almost imperceptible indication of the existence of the treatment. Further, when applied in powder forms, the treatment materials can be easily displaced during common cleaning practices such as sweeping or vacuuming.

Another issue with many extermination materials, particularly dry treatment materials, is that the introduction of moisture or high humidity can detract from the desired application process as well as the effectiveness of the treatment material. As such, mopping and/or other wet cleaning activities can both remove a substantial portion of exposed treatment materials and also render any remaining treatment material unsuitable for its intended purpose. Facilities with multiple rooms and/or large user or guest turnover rates, such as hotels and other lodging facilities, can be particularly prone to pest infestations, such as bed bugs as well as other pests, and the necessity of repeated cleanings for new guests make it difficult to maintain a desired level of extermination materials in desired areas or areas prone to infestation or surrounding areas.

The traditional application of extermination materials along base boards also fails to adequately address movement of pests from room to room, through wall recesses, or internal to wall covers. Providing exterminating material directly to the wall cavity is especially appealing in these situations, as it mitigates lateral movement of the pests to adjacent living spaces and exposes unseen pests to the extermination material.

One such solution has been to install a trap into a wall cavity. Such traps can be constructed to attract, trap, and/or kill pests but this solution is not without drawbacks. This solution requires permanent insertion of a trap into the wall cavity. Commonly, a hole is first cut into the wall covering material at the location when the trap is intended to be inserted. The hole can then be covered and/or patched but more commonly is left exposed to the living space to facilitate interaction with the trap device. This process can be time consuming and costly, results in dead space cavities in the wall where the trap is located, can be unsightly if left exposed, and provides an indication to users, guests, or tenants as to the existence of the trap and thereby an underlying indication as to a current or past pest issue.

One example of a common pest that is killed by spreading of a powdered extermination materials is bed bugs although other pest infestations can be treated in similar manners. Bed bugs are known for their rapid spreading, evasiveness to traditional treatment methods, and the difficulty with which to fully exterminate an infected area. An even larger issue with bed bugs is that they often infiltrate adjacent rooms and dwelling spaces through wall cavities by traveling along electrical and mechanical lines that extend between discrete units. In the past this has resulted in extremely expensive extermination proceedings with limited success. Traditionally, a dielectric earth powder is used to combat a bed bug infestation by applying the material about the infected area. This material cuts the outer anatomy of bed bugs resulting in the dehydration and eventually death of pests. However, as explained above, this powder can be easily displaced and can be rendered ineffective when exposed to moisture. This has further limited the success with which bed bug infestations have been treated.

Accordingly, there is a need for a device or appliance and method of treating pest infestations that improves the efficacy associated with each application of the extermination material. There is a further need for an application device and method that facilitates application of the extermination material into wall cavities or other structural areas not commonly exposed to the living space to mitigate recollection of the treatment materials during cleaning processes, to facilitate more economical and less apparent treatment applications, and to better mitigate the spread of the infestation to adjacent living spaces.

### BRIEF DESCRIPTION OF THE INVENTION

The present invention provides an extermination treatment appliance and a method of treating a pest infestation that overcomes one or more of the drawbacks mentioned above. One aspect of the invention discloses an extermination treatment appliance that includes a chamber, a gas source, and an applicator that are fluidly connected to one another. The chamber is configured to contain a volume of an extermination treatment material that is communicated to the applicator by a flow that originates from the gas source. An agitator may optionally be associated with the chamber to facilitate movement of the atomized exterminating treatment material toward an outlet defined by the chamber. The applicator preferably includes a trigger that is operable such that exterminating treatment material communicated to the applicator is atomized and expelled from the applicator when the trigger is actuated. The applicator further includes an injector that is constructed to be pressed through a wall covering material or surface, such as drywall or gypsum wall board, such that the atomized exterminating treatment material is expelled into a wall cavity. Differing injector configurations may be used to allow the injector to penetrate wall surfaces of differing thicknesses without adversely affecting moisture barriers which may be positioned therebehind.

Another aspect of the invention discloses a method of treating a pest infestation. The method includes pressing an injector supported by an applicator through an internal wall covering material, communicating a powder treatment material to the applicator with a gas stream, atomizing the powder treatment material, and expelling the atomized powder treatment material out of the injector. As a result, the atomized powder treatment material is dispersed or dispensed to the spaces behind wall covering materials. The injector may feature a stop that abuts an outward facing side of the wall covering material to prevent passage of a discharge port of the injector beyond a vapor barrier located generally in close proximity behind the wall covering material.

A further aspect of the invention discloses a system for delivering a powderized exterminating treatment material. The system includes a first flow path that extends between a gas source and a chamber that holds the powderized exterminating treatment material. A second flow path extends between the chamber and an applicator and a third flow path extends between the gas source and the applicator. Actuation of a trigger initiates flow along the flow paths to communicate the powderized exterminating treatment material from the chamber to the applicator and out a discharge tip. An injector cooperates with the applicator and is constructed to penetrate wall surfaces and propel atomized exterminating treatment material into a wall cavity. The system may further include at least one of a pair of shoulder straps and a handle to support and/or facilitate transportation of the system.

It is appreciated that the aspects and features of the invention summarized above are not limited to any one particular embodiment of the invention. That is many or all of the aspects above may be achieved with any particular embodiment of the invention. Those skilled in the art will appreciate that the invention may be embodied in a manner preferential to one aspect or group of aspects and advantages as taught herein. These and various other aspects, features, and advantages of the present invention will be made apparent from the following detailed description and the drawings.

### BRIEF DESCRIPTION OF THE DRAWINGS

The drawings illustrate a preferred embodiment presently contemplated for carrying out the invention.

FIG. 1 is an isometric view of the extermination treatment appliance in use with a wall surface:

FIG. 2 is schematic view of the extermination treatment appliance of FIG. 1; and

FIG. 3 is a flow chart demonstrating a method of treating a pest infestation with the appliance shown in FIG. 1.

### DETAILED DESCRIPTION OF THE PREFERRED EMBODIMENT

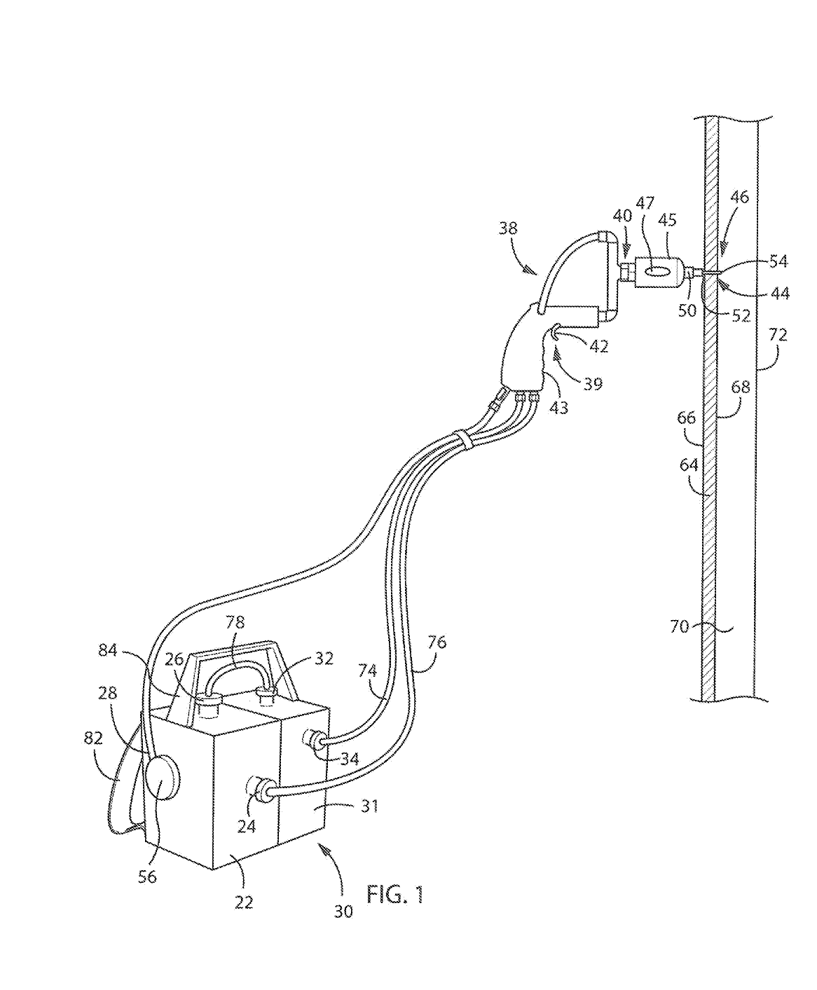

FIG. 1 shows an extermination treatment device, system, or appliance 20 according to the present invention. The extermination treatment appliance 20 includes a chamber 22 configured to receive an exterminating treatment material, such as a powderized exterminating treatment material. The chamber 22 is in fluid connection with a gas source 30 and an applicator 38. The flow of pressurized gas from the gas source 30 to the chamber 22 communicates the powderized exterminating treatment material to an applicator 38 associated with the intended or desired delivery of the powderized extermination treatment material to a treatment environment. As disclosed further below, applicator 38 is constructed to expel the atomized exterminating treatment material to an intended, treatment area.

The chamber 22 is initially filled with an exterminating treatment material, for instance, a powder treatment material. The chamber 22 will preferably have a removable lid or other opening cover that allows the exterminating treatment material to be poured from a bag or package into the interior of the chamber 22. The efficiency of certain type of exterminating materials, specifically powdered material, can be improved by atomizing or mitigating compaction or clumping of the dry treatment materials. Preferably, the dry treatment material is flowable via a gas stream or flow such that subjected the volume of chamber 22 to a flow associated with a pressurized gas source 30 effectuates communication of the dry treatment material to applicator 38.

Chamber 22 is designed to withstand the pressures associated with the introduction of a gas from a gas source 30. The lid or cover is also constructed to securely cooperate with the chamber 22 after the exterminating treatment material is added thereto to withstand the resulting pressure once the chamber 22 is connected to the gas source 30. A pressure gauge 23 may be mounted to the chamber 22 to monitor the pressure of the contents and/or the respective fluid communication system. As used herein, the term “fluid” is indicative of the flowable nature of the dry treatment material when subject to a flow associated with source 30 rather than any particularly state of the matter associated with the treatment material and the gas flow. Preferably, the treatment material and the gas flow are both provided with low or negligible moisture values to promote atomization of the dry treatment material and mitigate clumping of the same commonly attributable to moisture or humidity being present or at unacceptable levels either during storage or use of the application treatment system.

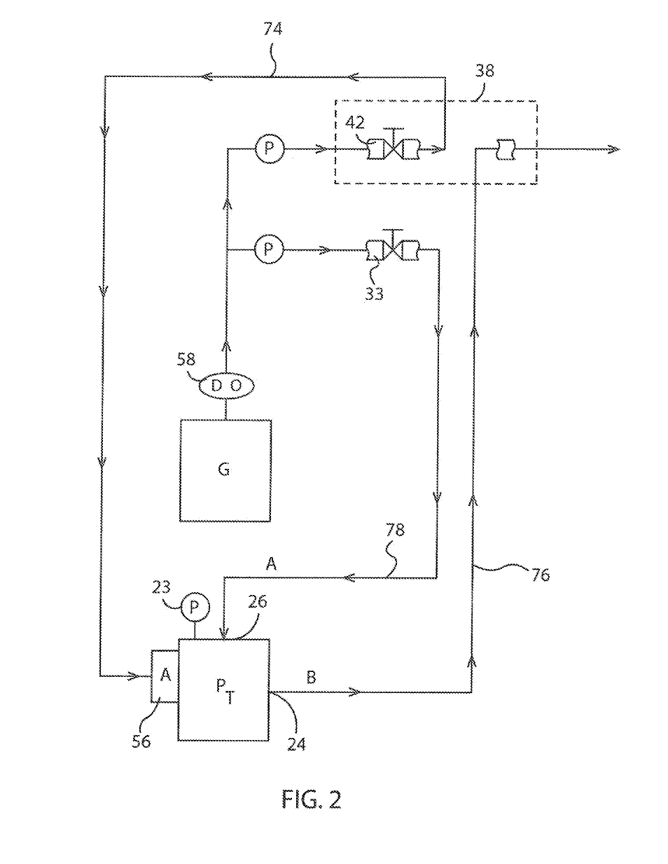

As alluded to above, gas source 30 preferably houses a low moisture content or thy gas to mitigate the introduction of humidity into the treatment material as many dry exterminating treatment materials are less effective when exposed to moisture and/or unable to attain a desired spreading or atomization during application when moisture is present. For instance, the gas source 30 may provide a flow of nitrogen gas, which is known as one of the driest gases. Alternatively, carbon dioxide may be used as it is a dry gas that attracts certain types of pests, for instance, bed bugs. Alternatively still, the gas may pass through a dryer 58, as shown in FIG. 2, to reduce its moisture content prior to introduction to the chamber 22. Multiple driers may be used throughout the system to ensure that the gas is properly conditioned before it enters the chamber 22. This configuration allows a user to have flexibility in selecting the type of gas for use with the extermination treatment appliance 20.

Still referring to FIG. 1, the gas source 30 is housed in a chamber 31 similar to the chamber 22 for the exterminating treatment material. This allows the gas source 30 and chamber 22 to be easily and conveniently transported, for instance, using shoulder straps 82, a handle 84, etc. Although a more portable design is shown in FIG. 1 which would allow a user to comfortably move about an infected area and carry the extermination treatment appliance 20, other configurations are envisioned, such a cart or the like or a larger base unit having an applicator that is connected to the base unit by longer connecting lines such that the user or technician can move about an environment and only periodically reposition the base unit. It is further appreciated that chamber 22 and gas source 30 may be independent from another and/or severable from one another to facilitate more convenient transportation and/or storage of discrete portions of appliance 20. For instance, larger and/or separate gas sources 30 and chambers 22 may be transported using carts as alluded to above or may include dedicated roller assemblies. Such a configuration would allow a user, or group of users, to apply the exterminating treatment material to larger spaces while mitigating the need to frequently refill or replace one or more of gas source 30 and/or the treatment material.

Still referring to FIG. 1, applicator 38 features a housing 39 that generally defines a handle 43 that supports a trigger 42. The housing 39 supports, includes, or defines a number of flow paths, indicated by a plurality of tubes or pipes. The trigger 42 is used in connection with at least one of these flow paths to actuate movement of gas and the treatment material through the extermination treatment appliance 20 and into a wall cavity as described further below. The housing 39 extends to a discharge end 40 that is configured to cooperate with an injector 44. Injector 44 can be provided in various configurations which each can be removed and secured to the discharge end 40 such that injectors can be said to interchangeable. The various injector(s) are configured to be useable and/or compatible with a respective wall covering 64 of differing thicknesses. For instance, different injectors 44 are dimensioned to penetrate various thicknesses associated with standard sized dry wall such as ¼ inch, ⅜ inch, ½ inch, ⅝ inch and ¾ inch thicknesses. It is appreciated that such dimensions are merely exemplary and other dimensions are envisioned. It is further appreciated that a user or technician may include multiple injectors of the same configuration in the event a desired injector becomes damaged, bent, or otherwise unusable for a particular application and/or worn after periods of extended use.

Although various injectors 44 are available, each features similar components with differing dimensions. The injector 44 cooperates with a vial, sight glass, or reservoir 45 that includes a shoulder 50 and funnels down into a discharge port 46 defined by a small tube or channel. The reservoir 45 may feature a window 47 that is translucent or transparent to allow a user to visually inspect the contents of the reservoir 45 and the flow of the exterminating treatment materials through the applicator 38 and toward port 46 defined by injector 44. When there is no exterminating treatment material within the reservoir 45, the user can refill the chamber 22 with exterminating treatment material or cheek for other plugs or blockages throughout the extermination treatment appliance 20. From the reservoir 45, discharge port 46 is defined by an opening 54, which constitutes an exit through which the exterminating treatment material can be expelled from the injector 44. Injector 44, and/or shoulder 50 associated with reservoir 45, define a stop 52 that is offset from discharge opening 54 associated with injector 44. Stop 52 is generally defined as a change in an outer diameter associated with injector 44 so as to prevent further movement of the injector 44 through wall covering 64. The longitudinal spacing of stop 52 relative to discharge opening 54 is selected such that discharge opening 54 is exposed through or flush with an interior facing side 68 of wall covering 64 when stop 52 is in abutting engagement with a living space or exterior facing side 66 of wall covering 64.

The discharge port 46 of the injector 44 preferably penetrates and is maintained in close proximity to the wall covering 64 although it is envisioned that, even if injector 44 achieves a close but non-penetrating or non-protruding orientation relative to the interior facing side 68 of wall covering 64, appliance 20 is operable in a manner wherein any remaining thickness of wall covering will be move to non-obstructing orientations relative to discharge opening 54 upon actuation of trigger 42.

As alluded to above, injector 44 can be pressed through wall covering 64 until stop 52 abuts an outward facing side 66 of wall surface 62. In this position the discharge opening 54 preferably extends slightly past the interior facing side 68 of the wall covering 64. Stop 52 prevents further movement of the discharge port 46 beyond a predefined distance associated with the longitudinal length of injector 44 between stop 52 and discharge opening 54. Such a construction mitigates penetration of the vapor barrier 72 and ensures dispensing of the treatment material between the vapor barrier 72 and the interior facing side 68 of wall covering 64. This configuration allows the exterminating treatment material supplied to the applicator 38 to be expelled into the wall cavity 70. The atomized exterminating treatment material can then be spread throughout the wall cavity and any electrical or mechanical lines that could serve as a transportation surface for the pests. Frequently, a vapor barrier is provided as a backer physically associated with insulation such that the introduction of the treatment materials to areas associated with insulation materials would detract from the preferred distribution of the treatment material in the wall cavities. As a result, lateral movement of the pests to different living spaces can greatly be reduced. Furthermore, as the wall cavity 70 is isolated from the living spaces, the exterminating treatment materials can be applied a single time without the detriments to effectiveness associated with moisture, suctioning, cleaning, and/or vacuuming common to the living spaces.

The discharge port 46 is configured to enter wall covering 64 and have sufficient diameter associated with opening 54 to allow for free flowing movement of the exterminating treatment material through the wall covering 64. Discharge port 46 preferably has a wall thickness that is sufficient to support the repeated manual pressing of the tube or needle portion of injector 44 through the material associated with wall covering 64. Understandably, some wall covering materials, such as plaster or stucco type materials may require the creation of an axis hole, such as by drilling or the like, to accommodate pressing of the injector 44 therethrough. It is appreciated that if a predrilled hole is necessary, the diameter of such a hole is selected such that injector 44 slidably and preferably sealingly cooperates with the hole so as to mitigate losses of treatment materials beyond the confines of the respective wall cavity.

The elongated portion of injector 44 preferably has an outside diameter that is selected so that injector 44 can tolerate being repeatedly pressed through many different wall cover materials but leaves only a small blemish to minimize the physical damage to the wall covering 64 when the injector is removed therefrom. That is, once injector 44 is removed from the wall covering 64, the resulting opening may be small enough to be unnoticeable to most bystanders. Alternatively, the opening may be covered with paint, spackling, or other materials as known in the art. Those skilled in the art will readily appreciate that the blemishes associated with introduction of injector 44 through wall covering 64 can be quickly and economically remediated after a treatment process.

The chamber 22, gas source 30, applicator 38, and other features connect using various flow paths in conjunction with inlets and outlets as will be described below. As shown, the flow paths constitute a series of tubular connections, although any pipes, tubes, hoses, or other connectors that can sustain operability when exposed to variable pressure flows may be used. Various pressure gauges may be mounted about the system to ensure that the pressure throughout the system does not exceed a desired level. Further still, various switches or flow moderators may be mounted throughout the system to allow a user to limit movement of gas or exterminating treatment material about the appliance 20. An exemplary embodiment of the extermination treatment appliance 20 shown in FIG. 1 is shown schematically in FIG. 2.

It is appreciated that the schematic representation shown in FIG. 2 is indicative of but one configuration associated with of achieving the objectives associated with operation of appliance 20. Further, although various flow control mechanisms are shown in the schematic representation shown in FIG. 2, it is further appreciated that appliance 20 may be provided in configuration wherein the desired operation of the underlying appliance can be effectuated with different degrees of user interaction with the appliance 20. In a simplest aspect, once a gas source is connected to a source of insect treatment materials and an applicator connected thereto, subsequent actuation of an operator, such as trigger 42 could effectuate discrete applications of the treatment material with no further user configuration of the system required. Preferably, each of the gas source, chamber associated with the treatment material, and the applicator are provided in a plug-and-play configuration wherein the various components are connectable with no or very few conventional tools such as pliers or the like.

Referring to FIGS. 1 and 2, the chamber 22 features two inlets 26, 28 and one outlet 24. The first inlet 26 of the chamber 22 connects directly to a first outlet 32 associated with gas source 30 and utilizing a third flow path 78. The third flow path 78 includes a switch 33 that allows the user to activate flow of gas from the first outlet 32 of the gas source 30 to the first inlet 26 of the chamber 22 to achieve a desired pressure at the chamber 22. The desired pressure at the chamber 22 occurs when the exterminating treatment material and the volume associated with the chamber 22 has sufficient pressure to transport the exterminating treatment material to applicator 38. For instance, although a maximum pressure is 110 pounds per square inch (PSI) is indicated, it has been shown that operating pressures of approximately 40 pounds per square inch are sufficient as higher pressure forces may cause damage to the wall covering 64. It is appreciated that other operating pressures may prove suitable for other application event and may further be tailored for use of appliance with wall coverings having different nominal thicknesses.

As the exterminating treatment material is extracted from chamber 22, due to the fine powder nature of the material, it may stick to the sidewalls of the chamber 22 or otherwise cavitate or become suspended in chamber 22 such that, although material is present, the material no longer flows toward applicator 38. To address this issue, an agitator 56 may be located proximate chamber 22 to encourage movement of the exterminating treatment material toward outlet 24. For instance, a vibrator or agitator may be employed that is pneumatically or electrically powered to effectuate the agitation of the contents of chamber 22. When provided as a pneumatic agitator, agitator 56 could be powered by pressurized gas from the gas source 30 before or simultaneously as the pressurized gas is supplied to the chamber 22 using the second inlet 28. Alternative actuators could also be used such as an electromagnetic actuator. Such a configuration would provide a low voltage option associated with agitation of the contents of the chamber. Agitators 56 may not be necessary, for instance, with portable extermination treatment appliances 20, movement of the user may be sufficient to encourage movement of the exterminating treatment materials toward the outlet associated with the respective material chamber or container. Examples of portable extermination treatment appliances 20 include those using a shoulder strap 82 such as in a backpack configuration and/or handle 84.

Referring to FIGS. 1 and 2, gas source 30 features a second outlet 34 that is connected to a first flow path 74. The first flow path 74 extends from the second outlet 34 to the applicator 38. Within the applicator 38, the first flow path 74 is coupled to the trigger 42. The trigger 42 constitutes a switch, which allows a user to open or close the first flow path 74. It is envisioned that trigger 42 can be provided as two stage trigger wherein partial actuation of the trigger directs a gas flow to chamber 22 to allow the chamber 22 to maintain a constant operating pressure or provided as a supplemental gas flow passage, such as third flow path 78, as described above. It is envisioned that when provided as a two-stage trigger assembly, continued translation of trigger 42 relative to handle 43 results in a discharge of the treatment material from injector 44. Alternatively, it is envisioned that flow path 78 can be provided with an additional valve arrangement wherein the user can independently direct a flow of gas from source 30 to chamber 22. When provided in such a configuration, it is envisioned that the valve associated with the selective connectivity between source 30 and chamber 22 be provided proximate applicator 38. Each of the configurations described above allow the user to use the applicator 38 to apply the exterminating treatment material without the need to continually monitor and check that sufficient gas pressure is maintained in the chamber 22. As such, the third flow path 78 could be eliminated altogether and the gas source 30 could exclusively be connected to the chamber 22 using the first flow path 74.

Finally, the chamber 22 also has an outlet 24 that connects to the applicator 38 through the second flow path 76. More specifically, the second flow path 76 selectively connects gas source 30 to the discharge end 40 of the applicator 38 such that actuation of trigger 42 effectuates communication of a gas flow through reservoir 45, atomizes a portion of the treatment material contained therein, and delivers the atomized flow of treatment material to the opening 54 associated with injector 44.

During operation, when the user actuates the trigger 42, or a separately operable valve in some embodiments, the gas source 30 provides pressurized gas through the first flow path 74 into the chamber 22. The exterminating treatment material contained in chamber 22 is directed to outlet 24 and via, second flow path 76 to the applicator 38. The second flow path 76 is associated with the discharge end 40 of the applicator 38. Thereafter, the exterminating treatment material flows into the reservoir 45 disposed upstream of injector 44. Exterminating treatment material associated with reservoir 45 is atomized or suspended in the flow gas and is then expelled out through the opening 54 defined by discharge port 46. In this way, the trigger 42 controls flow of the atomized exterminating material throughout the appliance 20 and out of the applicator 38.

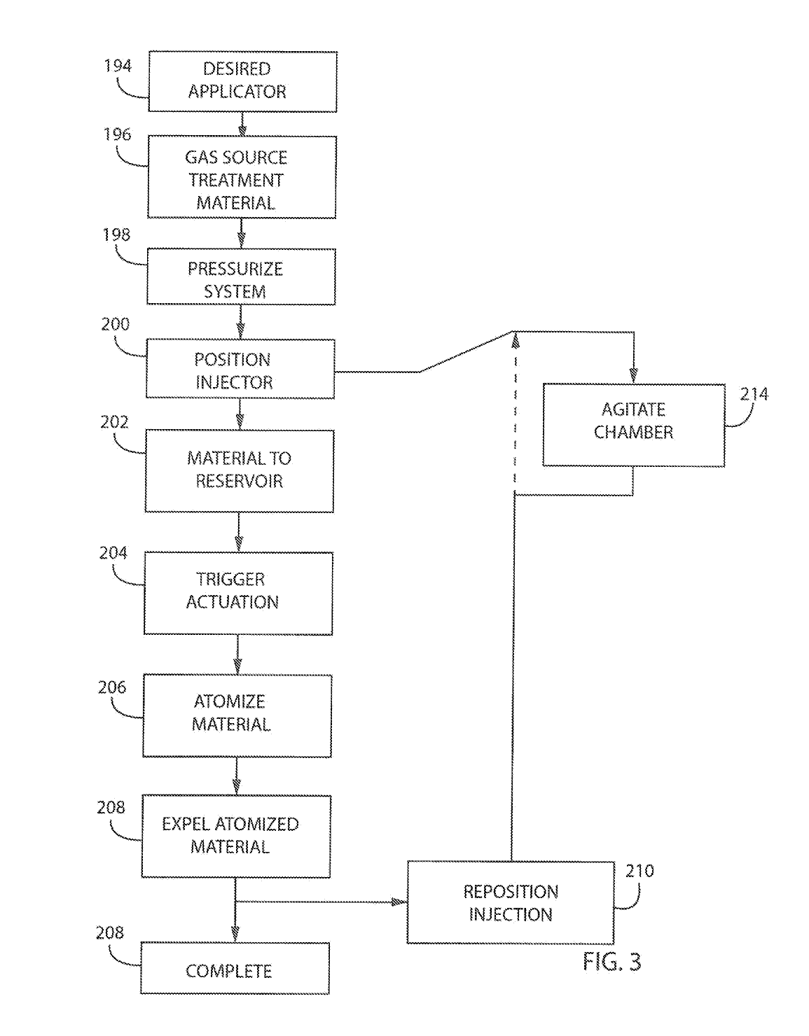

A further embodiment of the invention includes a method of using the extermination treatment appliance 20 described to treat pest infestations. The sequence associated with operation of the extermination treatment appliance 20 is shown graphically in FIG. 3. Once the system is provided a desired injector 44, 194, a desired gas source 30 and treatment material, 196, and initially pressurized such that a portion of treatment material is present at reservoir 45, 198, system 20 is configured to deliver the desired treatment material to those portions of a structure generally hidden from the living spaces. Once system 20 is configured for operation, method includes pressing the injector through a walling covering 200 such that the discharge opening 54 associated with injector 44 is disposed proximate the interior side 68 of wall coveting 64.

During continued operation, the powder treatment material associated with chamber 21 is communicated to reservoir 45 associated with applicator 38, 202. Each actuation of the trigger 204 atomized the powder treatment material 206 associated with reservoir 45. The atomized powder treatment material is expelled from applicator 208 through a wall surface and dispersed into a wall cavity located behind the inner facing side of the wall covering material. The treatment process described above can be repeated for each wall cavity associated with a living space intended to be treated by the repeated repositioning of the injector 210 into each wall cavity associated with an area to be treated until the treatment process is complete 212. Additionally, for those configurations that require such operation, the method can further include a step of intermittently agitating 214 the chamber associated with the treatment material to maintain a desired amount of treatment material at reservoir 45 associated with applicator 38.

As alluded to above, different injectors may be available, with each injector having a differing longitudinal length between a discharge port 46 and a shoulder 208. An injector may be selected based on thickness of the drywall material 212. A stop of the injector or defined by applicator 38 abuts an outward facing side of the wall covering material and prevents passage of the discharge port beyond a vapor barrier positioned adjacent the inner facing side of the internal wall covering material.

The present invention has been described in terms of the preferred embodiments, and it is recognized that equivalents, alternatives, and modifications, aside from those expressly stated, are possible and within the scope of the appending claims. For instance, the specific configuration of the various flow paths, switches, pressure gauges, and other features need not be limited to those shown in the figures. Other configurations and other components could be used to achieve the same goal, as would be recognized by one skilled in the art. Furthermore, the method need not occur in the specific order explained above. Additional steps may be added to further facilitate functionality, or some steps could be excluded as needed. It is further appreciated that the respective features of any one of the embodiments discussed above is not necessarily solely exclusive thereto.

What is claimed is:

1. An extermination treatment appliance comprising:
a chamber configured to contain an exterminating treatment material;
a gas source fluidly connected to the chamber and configured to communicate a gas stream thereto; and
an applicator connected to the chamber and the gas source; and
a trigger associated with the applicator and being operable to communicate the gas stream to the chamber to communicate the exterminating treatment material to the applicator and expel an atomized flow of the exterminating treatment material from the applicator in response to actuation of the trigger.

2. The extermination treatment appliance of claim 1 further comprising an agitator proximate to the chamber.

3. The extermination treatment appliance of claim 2 wherein the agitator vibrates the chamber to move the exterminating treatment material towards an outlet in the chamber.

4. The extermination treatment appliance of claim 1 wherein the gas source is further defined as a pressurized source as at least one of nitrogen, carbon dioxide, and a low moisture content gas source.

5. The extermination treatment appliance of claim 1 further comprising a dryer associated with the gas source and disposed between the chamber and the gas source.

6. The extermination treatment appliance of claim 1 wherein the applicator further comprises an injector associated with a discharge end of the applicator and the injector is constructed to be pressed through a drywall wall surface.

7. The extermination treatment appliance of claim 6 further comprising a plurality of injectors wherein each injector has a different longitudinal length that is selected such that a discharge port defined by each injector is exposed to an internal facing side of the drywall wall surface when the respective injector penetrates a respective wall surface.

8. A method of treating a pest infestation, the method comprising:
pressing an injector that defines a discharge port and is supported by an applicator through an internal wall covering material;
communicating a powder treatment material to the applicator with a gas stream; and
atomizing the powder treatment material communicated to the applicator with a gas stream and expelling the powder treatment material via the discharge port defined by the injector such that the atomized powder treatment material is dispersed about an exit of the injector from an inner facing side of the internal wall covering material.

9. The method of claim 8 further comprising selecting the injector from a group of injectors wherein each injector of the group of injectors has a longitudinal length between a discharge port and a shoulder that is different than a longitudinal length of the other injectors.

10. The method of claim 9 wherein pressing the injector through an internal wall covering material further comprises abutting a stop of the injector into engagement with an outward facing side of the internal wall covering material to prevent passage of the discharge port beyond a vapor barrier positioned adjacent the inner facing side of the internal wall covering material.

11. The method of claim 9 further comprising selecting an injector from the group of injectors based on the longitudinal length of the respective injector of the group of injectors correlating to a respective thickness of wall covering material, wherein the longitudinal length of each injector correlates to a respective thickness of wall covering material.

12. The method of claim 8 further comprising activating a trigger associated with the applicator to concurrently inject the atomized exterminating treatment material into a respective all cavity and communicate the powder treatment material to the applicator.

13. A system for delivering a powderized exterminating treatment material, the system comprising:
a first flow path extending between a gas source and an inlet of a chamber configured to contain a volume of the powderized exterminating treatment material;
a second flow path extending between an outlet of the chamber and a first inlet associated with an applicator such that the powderized exterminating treatment material is communicated to the applicator via the second flow path; and
a trigger configured to actuate flows along the first flow path and the second flow path to communicate the powderized exterminating treatment material from the chamber to the applicator and in an atomized form from a discharge port supported by the applicator.

14. The system of claim 13 further comprising an injector constructed to cooperate with the applicator and to penetrate wall surfaces.

15. The system of claim 13 further comprising a plurality of injectors wherein each injector includes a discharge opening that is oriented at a crossing orientation relative to a longitudinal axis of the respective injector and the discharge opening associated with each respective injector is offset a different respective distance from a stop than the discharge opening of the other respective injectors.

16. The system of claim 15 wherein each of the plurality of injectors is configured to propel atomized exterminating treatment material into a wall cavity and each of the different respective distances is associated with a respective nominal thickness of drywall.

17. The system of claim 13 further comprising an agitator associated with the chamber and configured to agitate the volume of the powderized exterminating treatment material.

18. The system of claim 13 further comprising at least one of a pair of shoulder straps and a handle for effectuating transportation of the system.

19. The system of claim 13 further comprising a reservoir configured to contain a portion of the powderized exterminating treatment material downstream of the second inlet and upstream of the discharge port of the injector.

20. The system of claim 19 wherein the reservoir is at least one of transparent or translucent to allow visual inspection of the contents of the reservoir.
